(19) United States
(12) Patent Application Publication
(10) Pub. No.: US 2017/0279640 A1
(43) Pub. Date: Sep. 28, 2017

(54) SYSTEMS AND METHODS FOR TRAINING FIELD BOOSTING

(71) Applicant: QUALCOMM Incorporated, San Diego, CA (US)

(72) Inventors: Lin Yang, San Diego, CA (US); Bin Tian, San Diego, CA (US)

(21) Appl. No.: 15/466,645

(22) Filed: Mar. 22, 2017

Related U.S. Application Data
(60) Provisional application No. 62/313,553, filed on Mar. 25, 2016.

(51) Int. Cl. H04L 25/02; H04L 27/26; H04L 1/00

(52) U.S. Cl. CPC H04L 25/0202; H04L 1/0003; H04L 27/2649; H04W 84/12

(57) ABSTRACT

A method performed by an electronic device is described. The method includes receiving a long training field (LTF) in a preamble of a packet. A power of the LTF is boosted relative to a power of a data field of the packet. The method also includes receiving a power amplifier (PA) model or a PA distortion error from a transmitting device. The method further includes regenerating a post-PA transmitted LTF based on the PA model or the PA distortion error. The method additionally includes demodulating the data field based on an estimated channel with deboosting.

### RELATED APPLICATION

This application is related to and claims priority to U.S. Provisional Patent Application Ser. No. 62/313,553, filed Mar. 25, 2016, for “SYSTEMS AND METHODS FOR BOOSTING A TRAINING FIELD.”

### TECHNICAL FIELD

The present disclosure relates generally to communication systems. More specifically, the present disclosure relates to electronic devices for training field boosting.

### BACKGROUND

Communication systems are widely deployed to provide various types of communication content such as data, voice, and video and so on. These systems may be multiple-access systems capable of supporting simultaneous communication of multiple communication devices (e.g., wireless communication devices, access terminals, etc.) with one or more other communication devices (e.g., base stations, access points, etc.).

Use of communication devices has dramatically increased over the past few years. Communication devices often provide access to a network, such as a Local Area Network (LAN) or the Internet, for example. Other communication devices (e.g., access terminals, laptop computers, smart phones, media players, gaming devices, etc.) may wirelessly communicate with communication devices that provide network access. Some communication devices comply with certain industry standards, such as the Institute of Electrical and Electronics Engineers (IEEE) 802.11 (e.g., Wireless Fidelity or “Wi-Fi”) standards. Communication device users, for example, often connect to wireless networks using such communication devices.

As the use of communication devices has increased, advancements in communication device performance are being sought. Systems and methods that improve communication device performance may be beneficial.

### SUMMARY

A method performed by an electronic device is described. The method includes receiving a long training field (LTF) in a preamble of a packet. A power of the LTF is boosted relative to a power of a data field of the packet. The method also includes receiving a power amplifier (PA) model or a PA distortion error from a transmitting device. The method further includes regenerating a post-PA transmitted LTF based on the PA model or the PA distortion error. The method additionally includes demodulating the data field based on an estimated channel with deboosting. The PA distortion error may indicate a PA distortion applied to the LTF by the transmitting device.

The method may include determining the estimated channel based on the regenerated post-PA transmitted LTF. The method may include determining a noise estimate. Determining the estimated channel may be based on the received LTF, the regenerated post-PA transmitted LTF, and the noise estimate.

Regenerating the post-PA transmitted LTF may include adding the PA distortion error to a predetermined LTF to produce the post-PA transmitted LTF. Regenerating the post-PA transmitted LTF may include applying the PA model to a predetermined LTF to produce the post-PA transmitted LTF.

The power of the LTF may be boosted for multiple streams. The power of the LTF may be boosted for a modulation and coding scheme (MCS) that is higher than a base MCS. Boosting the power of the LTF may result in increased PA distortion for the LTF relative to PA distortion for the data field. Regenerating the post-PA transmitted LTF may reduce channel estimation error due to the increased PA distortion.

An electronic device is also described. The electronic device includes a receiver configured to receive a long training field (LTF) in a preamble of a packet. A power of the LTF is boosted relative to a power of a data field of the packet. The receiver is configured to receive a power amplifier (PA) model or a PA distortion error from a transmitting device. The electronic device also includes a processor configured to regenerate a post-PA transmitted LTF based on the PA model or the PA distortion error. The electronic device further includes a demodulator configured to demodulate the data field based on an estimated channel with deboosting.

A non-transitory tangible computer-readable medium storing computer-executable code is also described. The computer-readable medium includes code for causing an electronic device to receive a long training field (LTF) in a preamble of a packet. A power of the LTF is boosted relative to a power of a data field of the packet. The computer-readable medium also includes code for causing the electronic device to receive a power amplifier (PA) model or a PA distortion error from a transmitting device. The computer-readable medium further includes code for causing the electronic device to regenerate a post-PA transmitted LTF based on the PA model or the PA distortion error. The computer-readable medium additionally includes code for causing the electronic device to demodulate the data field based on an estimated channel with deboosting.

An apparatus is also described. The apparatus includes means for receiving a long training field (LTF) in a preamble of a packet. A power of the LTF is boosted relative to a power of a data field of the packet. The apparatus also includes means for receiving a power amplifier (PA) model or a PA distortion error from a transmitting device. The apparatus further includes means for regenerating a post-PA transmitted LTF based on the PA model or the PA distortion error. The apparatus additionally includes means for demodulating the data field based on an estimated channel with deboosting.

### BRIEF DESCRIPTION OF THE DRAWINGS

FIG. 1 is a block diagram illustrating an example of an electronic device in which systems and methods for training field boosting may be implemented;

FIG. 2 illustrates various components that may be utilized in an electronic device to transmit wireless communications;

FIG. 3 illustrates various components that may be utilized in an electronic device to receive wireless communications;

FIG. 4 is a block diagram showing one example of a preamble and data of a physical layer packet;

FIG. 5 is a flow diagram illustrating an example of a method for training field boosting;

FIG. 6 is a flow diagram illustrating an example of another method for training field boosting;

FIG. 7 is a flow diagram illustrating a more specific example of a method for training field boosting;

FIG. 8 is a flow diagram illustrating another more specific example of a method for training field boosting;

FIG. 9 is a flow diagram illustrating another more specific example of a method for training field boosting;

FIG. 10 is a flow diagram illustrating another example of a method for utilizing a boosted training field;

FIG. 11 is a diagram illustrating an example of a wireless communication system in which aspects of the systems and methods disclosed herein may be employed; and

FIG. 12 illustrates certain components that may be included within an electronic device.

### DETAILED DESCRIPTION

The systems and methods disclosed herein may relate to improving wireless communication. For example, the systems and methods disclosed herein may relate to training field (e.g., long training field (LTF)) boosting and/or power amplifier (PA) post correction.

A training field may be included in a wireless communication packet. For example, a wireless communication packet may include a preamble portion and a data field. The preamble portion may include a training field (e.g., LTF). The training field may be utilized by a receiver to estimate the communication channel.

In some wireless systems, boosting the training field (e.g., LTF) may be one way to improve channel estimation quality. For example, boosting the training field may include producing a training field with a higher power relative to the power of the data field. In some approaches, the power of the training field may be scaled relative to the power of the data field. For instance, the power of the training field may be 3 decibels (dB) higher than the power of the data field.

Boosting the training field (e.g., LTF) may introduce some issues that may potentially degrade communication performance. Accordingly, it may be beneficial to provide a way to mitigate the side effects of training field boosting and to make the boosting gain positively impact performance. Some configurations of the systems and methods disclosed herein may utilize power amplifier (PA) post correction to mitigate the side effects of training field (e.g., LTF) boosting and to make the boosting gain positively impact communication performance. A discussion follows of some of the issues that may arise from training field boosting and how these issues may be addressed.

At some higher modulation and coding schemes (MCS) and/or in approaches that utilize multiple streams (e.g., multiple input and multiple output (MIMO)), some issues may arise from training field (e.g., LTF) boosting. One issue may include an increased transmit error vector magnitude (Tx EVM). The increased Tx EVM may be mitigated by PA post correction. More detail regarding PA post correction is given later. Another issue that may arise is out of band emissions (OOBE). For example, boosting the training field may increase OOBE, which may not satisfy an interference requirement mask. It should be noted that while OOBE may increase for the training field (e.g., LTF), other symbols may have lower OOBE, so averaging over multiple symbols may help. Moreover, a low peak-to-average power ratio (PAPR) of LTFs and/or filtering of the OOB signal may address this issue, which will be further discussed later. The receiver analog-to-digital converter (ADC) range may be another issue to consider. In some implementations, a margin for high PAPR in the data portion may ameliorate this issue, unless the training field (e.g., LTF) is boosted too significantly.

One or more options may be implemented and/or utilized in accordance with the systems and methods disclosed herein. One option (e.g., option 1) may include using one or more training field sequences (e.g., new LTF sequences) with lower PAPR. These training field sequences may likely be time domain sequences. For example, a time domain constant modulo sequence with 0 dB PAPR may be utilized (instead of a frequency domain sequence, for instance). The receiver may estimate the channel based on the low PAPR training field sequence and may demodulate the data field based on the estimated channel with deboosting.

Another option (e.g., option 2) may include PA nonlinearity post correction. In particular, a received signal may be represented as Y=PA(LTF)H+n, where PA(LTF) is the output from the PA on the training field (e.g., LTF) segment (e.g., a post-PA training field), H is the channel, and n is noise. For example, Y=PA(LTF)H+n may be an expression of a frequency domain model of a communication system. PA(LTF) may be decomposed as PA(LTF)=LTF+Err(LTF), where Err(LTF) is a PA distortion error on the training field (e.g., LTF) segment. In some configurations, the transmitter may send a PA model and/or a PA distortion error to the receiver. The receiver may estimate the channel H using a regenerated post-PA transmitted training field (e.g., post-PA transmitted LTF) signal (e.g., a PA(LTF) signal). The post-PA transmitted training field may indicate the transmitted training field after PA operation. The receiver may demodulate the data field based on the estimated channel with deboosting.

Yet another option (e.g., option 3) may include performing clipping and digital predistortion (DPD). For example, the transmitter may power boost the training field (e.g., LTF) and clip the training field at a certain threshold. The transmitter may filter OOBE and may apply DPD. The transmitter may send the clipping level and/or the clipping error (e.g., Err(LTF)=(clipped(LTF)−LTF)) to the receiver. The receiver may regenerate the transmitted training field (e.g., post-PA transmitted LTF, actual transmitted LTF, etc.) based on a known sequence (e.g., known LTF sequence) and the clipping error and/or the clipping level. The receiver may convert the regenerated transmitted training field (e.g., regenerated post-PA transmitted LTF) to the frequency domain (using a fast Fourier transform (FFT), for example). The receiver may estimate the channel H using both the known sequence and the clipping error (e.g., LTF+Err(LTF)). The receiver may demodulate the data field based on the estimated channel with deboosting. It should be noted that one or more aspects of two or more of the options may be combined in some configurations.

It should be noted that the systems and methods disclosed herein may be applicable to one or more orthogonal frequency-division multiplexing (OFDM)-based standards. Wireless network technologies may include various types of wireless local area networks (WLANs). A WLAN may be used to interconnect nearby devices together, employing networking protocols. In some configurations, the various aspects described herein may apply to any communication standard, such as Wi-Fi or, more generally, any member of the Institute of Electrical and Electronics Engineers (IEEE) 802.11 family of wireless protocols. For example, the various aspects of some configurations described herein may be used as part of the IEEE 802.11ah protocol, which uses sub-1 gigahertz (GHz) bands. In particular, a new LTF sequence design may be utilized in some configurations (in option 1, for example). The new LTF sequence may be applicable in the 802.11ah standard, the 802.11ax standard, and beyond. Some configurations (e.g., option 2 and/or option 3) may be applicable to a variety of wireless communication standards.

In some configurations, wireless signals in a sub-gigahertz band may be transmitted according to the 802.11ah protocol using orthogonal frequency-division multiplexing (OFDM), direct-sequence spread spectrum (DSSS) communications, a combination of OFDM and DSSS communications, or other schemes. Implementations of the 802.11ah protocol may be used for sensors, metering, and smart grid networks. Advantageously, aspects of certain devices implementing the 802.11ah protocol may consume less power than devices implementing other wireless protocols, and/or may be used to transmit wireless signals across a relatively long range, for example about one kilometer or longer.

In some configurations, certain of the devices described herein may implement the 802.11ah standard, for example. Such devices, whether used as a station (STA) or an access point (AP) or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g., for use with hotspots), or to implement machine-to-machine communications.

Some configurations of the systems and methods disclosed herein may be applied to one or more other IEEE 802.11 standards (e.g., 802.11g, 802.11n, 801.11ac, 802.11ax, etc.). Some configurations of the systems and methods disclosed herein may be implemented independent of any particular wireless communication standard.

In some implementations, a WLAN includes various devices, which are the components that access the wireless network. For example, there may be two types of devices: access points (“APs”) and clients (also referred to as stations, or “STAs”). For instance, an AP may serve as a hub or base station for the WLAN and an STA may serve as a user of the WLAN. For example, a STA may be a laptop computer, a personal digital assistant (PDA), a mobile phone, etc. In an example, an STA connects to an AP via a Wi-Fi (e.g., IEEE 802.11 protocol such as 802.11ah) compliant wireless link to obtain general connectivity to the Internet or to other wide area networks. In some implementations, an STA may also be used as an AP.

An access point (“AP”) may also comprise, be implemented as, or be referred to as a NodeB, Radio Network Controller (“RNC”), eNodeB, Base Station Controller (“BSC”), Base Transceiver Station (“BTS”), Base Station (“BS”), Transceiver Function, Radio Router, Radio Transceiver, or some other terminology. One or more aspects of the systems and methods disclosed herein may be incorporated into an access point.

A station “STA” may also comprise, be implemented as, or referred to as an access terminal (“AT”), a subscriber station, a subscriber unit, a mobile station, a remote station, a remote terminal, a user terminal, a user agent, a user device, user equipment, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects of the systems and methods disclosed herein may be incorporated into a station, such as a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

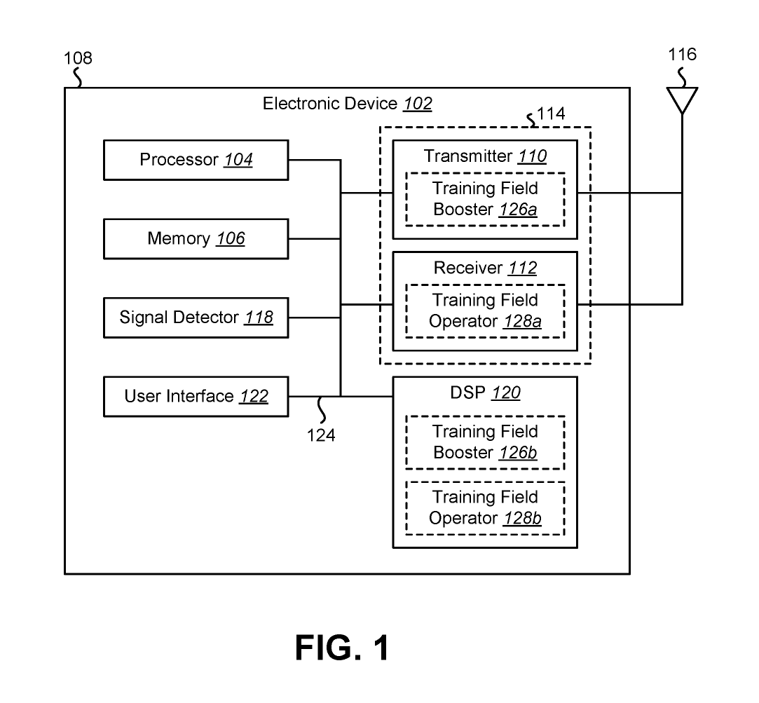

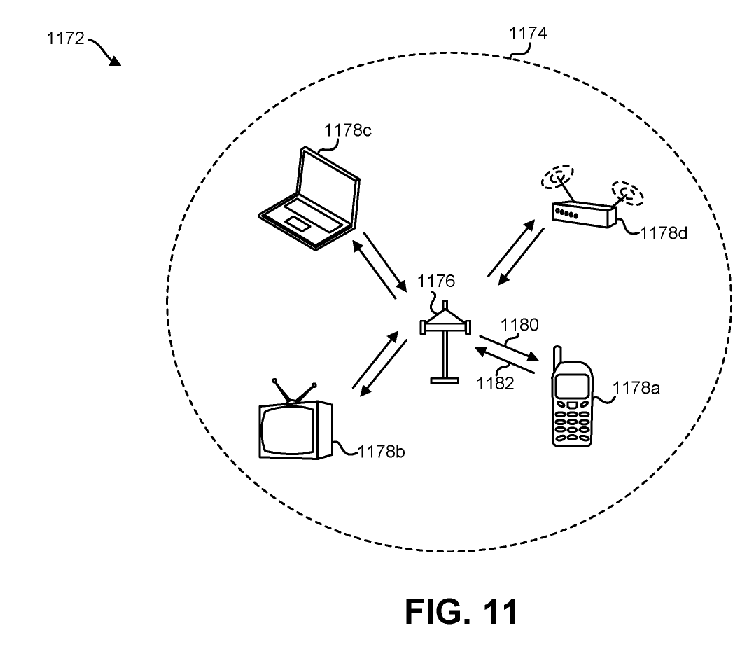

FIG. 1 is a block diagram illustrating an example of an electronic device 102 in which systems and methods for training field boosting may be implemented. In some configurations, the electronic device 102 may be employed within a wireless communication system (e.g., wireless communication system 1172 described in relation to FIG. 11). For example, the electronic device 102 may comprise an access point (AP) (e.g., the AP 1176 described in relation to FIG. 11) or a station (STA) (e.g., one of the STAs 1178 described in relation to FIG. 11). Examples of the electronic device 102 include wireless communication devices, cellular phones, smart phones, computers (e.g., desktop computers, laptop computers, etc.), servers, tablet devices, media players, televisions, vehicles (e.g., cars, trucks, aircraft, motorcycles, etc.), automobiles, cameras, video camcorders, digital cameras, personal cameras, action cameras, surveillance cameras, mounted cameras, connected cameras, robots, aircraft, gaming consoles, personal digital assistants (PDAs), set-top boxes, etc. The electronic device 102 may include one or more components or elements. One or more of the components or elements may be implemented in hardware (e.g., circuitry) or a combination of hardware and software (e.g., a processor with instructions).

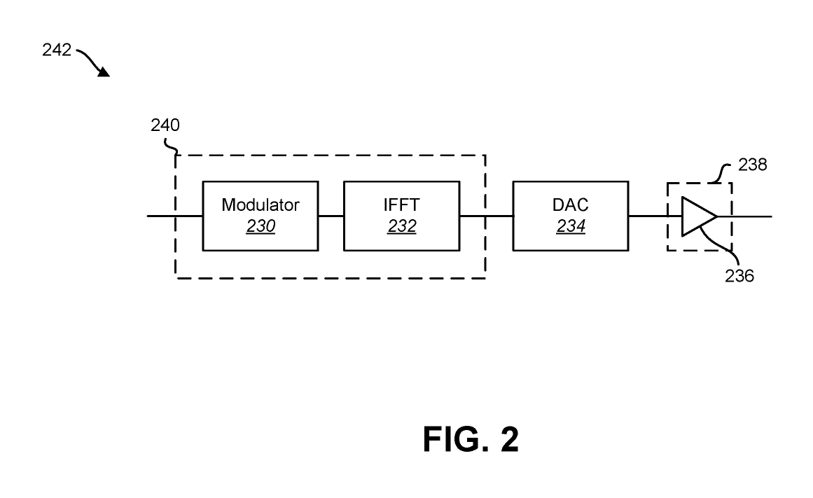

The electronic device 102 may be used to transmit and/or receive wireless communications signals. The electronic device 102 may employ training field (e.g., LTF) boosting in accordance with one or more of the configurations described herein. For example, the electronic device 102 may boost a training field of a preamble and/or may utilize a low PAPR training field, PA post correction, and/or clipping with DPD. Additionally or alternatively, the electronic device 102 may perform channel estimation based on the boosted training field and/or may demodulate a data field with deboosting. Examples of structures and/or methods that may be implemented by the electronic device 102 are described in relation to one or more of FIGS. 2-12.

The electronic device 102 may include a processor 104 that controls operation of the electronic device 102. The processor 104 may also be referred to as a central processing unit (CPU). Memory 106, which may include read-only memory (ROM) and/or random access memory (RAM), provides instructions and data to the processor 104. A portion of the memory 106 may also include non-volatile random access memory (NVRAM). The processor 104 typically performs logical and arithmetic operations based on program instructions stored within the memory 106. The instructions in the memory 106 may be executable to implement one or more of the methods described herein.

The processor 104 may comprise or be a component of a processing system implemented with one or more processors. The one or more processors may be implemented with one or more of (or any combination of) general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software may mean one or more kinds of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, may cause the processing system to perform one or more of the various functions described herein.

The electronic device 102 may also include a housing 108 that may include a transmitter 110 and a receiver 112 to allow transmission and reception of data between the electronic device 102 and a remote location. The transmitter 110 and receiver 112 may be combined into a transceiver 114. An antenna 116 may be attached to the housing 108 and electrically coupled to the transceiver 114. The electronic device 102 may also include (not shown) multiple transmitters, multiple receivers, multiple transceivers, and/or multiple antennas. It should be noted that the antenna 116 may include one or more internal antennas, one or more external antennas, or both.

The electronic device 102 may include a training field booster 126. In some configurations, the transmitter 110 may include the training field booster 126a. Additionally or alternatively, the DSP 120 may include the training field booster 126b. In some configurations, the training field booster 126 may be implemented in another component (e.g., the processor 104) or may be implemented by a combination of components (e.g., the processor 104 and the transmitter 110, the DSP 120 and the transmitter 110, etc.). As utilized herein, the generic reference to a training field booster 126 may refer generally to a training field booster 126 that may be implemented in the transmitter 110, the DSP 120, the processor 104, another element (e.g., separate circuitry in the electronic device 102), or in a combination of elements. The more specific reference to a training field booster 126a may refer to a training field booster 126a implemented in a transmitter 110, and the more specific reference training field booster 126b may refer to a training field booster 126b implemented in a DSP 120. In some configurations, the training field booster 126 may be implemented in a modulator.

The training field booster 126 may boost a power of a training field (e.g., a long training field (LTF)) in a preamble of a packet relative to a power of a data field of the packet. For example, the DSP 120 and/or transmitter 110 may produce a packet that includes a training field (e.g., LTF) and a data field, where the training field has a higher power than the data field. In some configurations, the training field booster 126 may control a modulator to produce a training field with a power that is higher relative to a power of the data field. For example, the modulator may increase the amplitude(s) of the training field (e.g., LTF). In some approaches, the training field booster 126 may scale the power of the training field relative to the power of the data field. For example, the power of the training field may be 3 dB higher than the power of the data field. Boosting the training field may include multiplying the training field by a factor. For instance, to boost the training field (e.g., LTF) by 3 dB, the training field sequence may be multiplied by the square root of 2 (e.g., sqrt(2), \sqrt{2}, etc.). In some approaches, the training field booster 126 may additionally or alternatively control a power amplifier (PA) to produce a training field with a power that is higher relative to a power of the data field.

In some configurations, the training field booster 126 may boost the training field (e.g., LTF) for multiple streams. For example, the training field booster 126 may boost the training field for a MIMO transmission with multiple data streams. Channel estimation may be performed for multiple streams. MIMO transmission may improve with better channel estimation. Accordingly, training field boosting may be beneficial. In some approaches, training field boosting may only be performed for multiple streams. For example, if the electronic device 102 is operating in a single-stream mode, the electronic device 102 may not perform training field boosting. Multiple streams may be sent and/or received by one or more devices (e.g., one or more electronic devices 102, one or more transmitting devices, and/or one or more receiving devices).

In some configurations, the training field booster 126 may boost the training field (e.g., LTF) for a modulation and coding scheme (MCS) that is higher than a base MCS (e.g., MCS>MCS0). For example, a base MCS may be binary phase-shift keying (BPSK) with rate 1/2. An example of a higher order MCS may be 1024 quadrature amplitude modulation (QAM) with rate 5/6. Other MCSs may be utilized that are higher order than the base MCS. Higher order modulation may improve with more accurate channel estimation for demodulation. Training field (e.g., LTF) boosting is an approach for achieving more accurate channel estimation. In some approaches, training field boosting may only be performed for one or more MCSs that are higher than the base MCS. For example, if the electronic device 102 is utilizing a base MCS, the electronic device 102 may not perform training field boosting. Additionally or alternatively, some configurations of the systems and methods disclosed herein may be applied for one or more high MCSs (e.g., higher MCS(s) than a low MCS like MCS0 for extended range application). For example, training field boosting may be applied for higher MCS(s) than a low MCS for extended range in IEEE 802.11ah or IEEE 802.11ax. For instance, some configurations of the systems and methods disclosed herein may apply to one or more higher MCSs and/or multiple streams. Some configurations of the systems and methods disclosed herein may relate to receiver processing (e.g., post PA correction) to bring up the gain.

In some configurations, the training field may be designed with a low peak-to-average power ratio (PAPR). For example, the low PAPR of the training field plus a power boosting amount in dB may be lower than an average PAPR of the data field. In some approaches, the training field may be a time domain sequence.

In some configurations, the electronic device 102 (e.g., transmitter 110) may send (e.g., transmit) a PA model. In some approaches, the PA model may be signaled and/or measured before the transmission of the training field through association. For example, the electronic device 102 (e.g., training field booster 126) may estimate the PA model based on a different packet (e.g., a different packet from the current packet with the training field). Additionally or alternatively, the PA model may be assumed transparent for transmit and/or receive sides for coordinating devices (e.g., products from a same manufacturer, products where the PA model is predetermined, and/or products where the PA model is known by the receiver, etc.) such that no signaling is needed. In some configurations, if the PA model is not signaled, the receiving device (e.g., training field operator 128b) may estimate the PA model through a beacon (e.g., neighbor discovery protocol (NDP)) packet or some known sequence.

The PA model may indicate one or more characteristics of a power amplifier (PA) of the electronic device 102 (e.g., of a transmitting device). For example, the PA model may indicate a transfer function of the PA, a distortion profile of the PA, etc. In some configurations, the PA model may be expressed as a polynomial. For example, the PA model may indicate a number of terms and corresponding coefficients. In some approaches, the PA model may be predetermined. For example, the PA model may be measured during calibration and stored in memory 106.

In some configurations, the training field booster 126 may determine a PA distortion error for the training field. The PA distortion error may indicate an amount of distortion introduced by the PA in boosting the training field (e.g., LTF). For example, the PA distortion error may indicate a PA distortion applied to the training field (e.g., LTF) by the transmitting device. Boosting the training field power may result in increased PA distortion for the training field relative to PA distortion for the data field. The PA distortion error may be calculated based on one or more PA parameters (e.g., clipping parameters, backoff, clipping threshold, etc.). In some approaches where the PA model is determined and/or known, the PA distortion error may be determined as Err(TF)=PA(TF)−TF (e.g., Err(LTF)=PA(LTF)−LTF), where TF may denote a training field (e.g., LTF denotes a long training field) and PA( ) may denote the PA model (e.g., PA model function). Additionally or alternatively, the PA distortion error may be determined as Err(TF)=clipping(TF)−TF (e.g., Err(LTF)=clipping(LTF)−LTF) in a case of clipping (assuming an ideal PA, for example), where clipping( ) is the clipping function. Other approaches may be utilized that do not assume an ideal PA and/or that utilize a non-ideal PA formulation.

The electronic device 102 (e.g., transmitter 110) may send (e.g., transmit) the PA distortion error to another device (e.g., a receiving device). In some approaches, the PA distortion error may be measured and/or signaled before the actual transmission (e.g., transmission of the training field) through association. Additionally or alternatively, one or more distortion-related parameters (e.g., PA distortion error, PA backoff, and/or clipping threshold) may be signaled in the packet (e.g., in the current packet with the training field) in a control field and/or through association.

In some configurations, electronic device 102 (e.g., transmitter 110, training field booster 126, etc.) may apply clipping and digital predistortion (DPD) to the training field (e.g., LTF). The clipping may be performed at a clipping level (e.g., an amount of clipping, a clipping threshold, etc.). The clipping may be performed in accordance with a clipping function. The clipping function may be predetermined in some approaches. The training field booster 126 may determine a clipping error for the training field. The PA clipping error may indicate an amount of error introduced by clipping the training field (e.g., LTF). In some configurations, the electronic device 102 (e.g., transmitter 110) may filter out-of-band emissions (OOBE). The electronic device 102 (e.g., transmitter 110) may send (e.g., transmit) the clipping level or the clipping error to another device (e.g., a receiving device). For example, the electronic device 102 may send the clipping level, the clipping error, and/or the clipped portion (e.g., Err(LTF)=(clipped(LTF)−LTF)) to another device (e.g., a receiving device). In some approaches, the clipping level (e.g., clipping threshold) and/or clipping error may be signaled in the packet (e.g., in the current packet with the training field) in a control field and/or through association.

In some configurations, the electronic device 102 (e.g., receiver 112) may receive a training field (e.g., LTF) in a preamble of a packet. The power of the training field may be boosted relative to a power of a data field of the packet. For example, the electronic device 102 may function as a receiving device and may receive one or more packets from a transmitting device (e.g., a remote device, another electronic device 102, etc.).

In some configurations, the receiver 112 may receive a PA model from a transmitting device. As described herein, the PA model may indicate one or more characteristics of a power amplifier (PA) of the transmitting device. In some configurations, the received PA model may indicate a polynomial (e.g., a number of terms and corresponding coefficients). Additionally or alternatively, the receiver 112 may receive a PA distortion error from a transmitting device. As described herein, the PA distortion error may indicate an amount of distortion introduced by the PA of the transmitting device in boosting the training field (e.g., LTF). Additionally or alternatively, the receiver 112 may receive a clipping level, clipping portion, and/or clipping error (e.g., Err(TF), Err(LTF), etc.).

The electronic device 102 may include a training field operator 128. In some configurations, the receiver 112 may include the training field operator 128a. Additionally or alternatively, the DSP 120 may include the training field operator 128b. In some configurations, the training field operator 128 may be implemented in another component (e.g., the processor 104) or may be implemented by a combination of components (e.g., the processor 104 and the receiver 112, the DSP 120, and the receiver 112, etc.). As utilized herein, the generic reference to a training field operator 128 may refer generally to a training field operator 128 that may be implemented in the receiver 112, the DSP 120, the processor 104, another element (e.g., separate circuitry in the electronic device 102), or in a combination of elements. The more specific reference to a training field operator 128a may refer to a training field operator 128a implemented in a receiver 112, and the more specific reference training field operator 128b may refer to a training field operator 128b implemented in a DSP 120.

In some configurations, the training field operator 128 may regenerate a post-PA transmitted training field (e.g., LTF) based on the PA model. The (regenerated) post-PA transmitted training field may be an estimate of the training field after PA operation as transmitted from the transmitting device. In some approaches, Y may denote the received training field, the PA model may be denoted PA( ) TF may denote the training field, H may denote the channel, and n may denote noise. The training field (e.g., TF, LTF, etc.) may be a predetermined sequence that is known by the electronic device 102 (e.g., transmitting electronic device and/or receiving electronic device). Regenerating the post-PA transmitted training field may include applying the PA model to the training field. For example, the regenerated post-PA transmitted training field may be denoted PA(TF) (e.g., PA(LTF)).

Additionally or alternatively, the training field operator 128 may regenerate a post-PA transmitted training field (e.g., LTF) based on the PA distortion error (e.g., Err(TF)). For example, the training field operator 128 may regenerate the post-PA transmitted training field (e.g., post-PA transmitted LTF) by adding the PA distortion error to a predetermined training field (e.g., PA(TF)=TF+Err(TF) or PA(LTF)=LTF+Err(LTF)). Regenerating the post-PA transmitted training field (e.g., LTF) may reduce channel estimation error due to the increased PA distortion.

Additionally or alternatively, the training field operator 128 may regenerate a post-PA transmitted training field (e.g., LTF) based on the clipping level, clipped portion, and/or clipping error. For example, the training field operator 128 may regenerate the training field after clipping and PA operation. For instance, the training field operator 128 may regenerate the post-PA transmitted training field (e.g., post-PA transmitted LTF) by adding the clipping error to a predetermined training field (e.g., clipped(TF)=Err(TF)+TF or clipped(LTF)=Err(LTF)+LTF). Additionally or alternatively, the training field operator 128 may regenerate the clipping error and convert it to the frequency domain (using a fast Fourier transform (FFT), for example).

In some configurations, the electronic device 102 (e.g., receiver 112, training field operator 128, processor 104, DSP 120, etc.) may determine an estimated channel based on the regenerated post-PA transmitted training field. In some approaches, the electronic device 102 may determine the estimated channel in accordance with Y=PA(TF)H+n. For example, the electronic device 102 (e.g., receiver 112, training field operator 128, etc.) may determine a noise estimate (e.g., n). The electronic device 102 may determine the estimated channel (e.g., H) based on the received training field (e.g., Y), the regenerated post-PA transmitted training field (e.g., the PA model or the PA distortion error and the known training field, PA(TF), etc.), and the noise estimate. Additionally or alternatively, the electronic device 102 may determine the estimated channel (e.g., H) based on the received training field (e.g., Y), the regenerated post-PA transmitted training field (e.g., the clipping error and the known training field, PA(TF), clipped(TF)=TF+Err(TF), clipped(LTF)=LTF+Err(LTF), etc.), and the noise estimate. Additionally or alternatively, the electronic device 102 may estimate the channel H using both the TF+Err(TF) (e.g., LTF+Err(LTF)) and deboosting.

The electronic device 102 (e.g., receiver 112, DSP 120, training field operator 128, channel estimator, and/or demodulator, etc.) may demodulate the data field based on the estimated channel with deboosting. For example, the electronic device 102 may utilize the estimated channel with deboosting in order to demodulate the data field of the received packet. In some approaches (at channel estimation, for example), the electronic device 102 may perform deboosting by dividing the estimated channel (e.g., channel estimate) by a factor. For instance, the electronic device 102 may divide the estimated channel by the square root of 2 (e.g., sqrt(2), \sqrt{2}, etc.). The channel estimate (e.g., deboosted channel estimate) may be utilized for demodulating the data field.

It should be noted that the electronic device 102 may be implemented and/or operate as a transmitting device with training field boosting. Additionally or alternatively, the electronic device 102 may be implemented and/or operate as a receiving device that receives a boosted training field. Accordingly, the electronic device 102 may be a transmitted device (that transmits to a remote receiving device), a receiving device (that receives from a remote transmitting device), or both.

In some configurations, the electronic device 102 may also include a signal detector 118 that may be used in an effort to detect and quantify the level of signals received by the transceiver 114. The signal detector 118 may detect such signals as total energy, energy per subcarrier per symbol, power spectral density and other signals. The electronic device 102 may also include a digital signal processor (DSP) 120 for use in processing signals. The DSP 120 may be configured to generate a data unit for transmission. In some aspects, the data unit may comprise a physical layer data unit (PPDU). In some aspects, the PPDU may be referred to as a packet.

Different configurations of the systems and methods described herein may be implemented for transmitting and/or receiving wireless signals in different bands. For example, some configurations may be implemented for transmission and/or reception in one or more sub-gigahertz (GHz) bands. Additionally or alternatively, some configurations may be implemented for transmission and/or reception in one or more other bands (e.g., 2.4 GHz, 5 GHz, etc.).

In some configurations, the electronic device 102 may be configured to operate according to one or more wireless standards. For example, the electronic device 102 may be configured to operate according to one of the 802.11 standards. For instance, the electronic device 102 may have a mode for operating in a 20 megahertz (MHz) channel width in the 2.4 GHz or 5 GHz band, as well as a mode for operating in a 40 MHz channel width in the 2.4 GHz band. In another aspect, the electronic device 102 is configured to operate pursuant to the 802.11ac standard. For example, the electronic device 102 may have a mode for operating in each of a 20 MHz, 40 MHz, and 80 MHz channel width. In some configurations, one or more of the transformers described herein (e.g., IFFT 232 and/or FFT 352) may use 64 tones when the electronic device 102 is operating in the 20 MHz band, may use 128 tones when the electronic device 102 is operating in the 40 MHz band, and may use 156 tones when the electronic device 102 is operating in the 80 MHz band. It should also be noted that 802.11ax may utilize 4× numerology, where 20 MHz may have a 256-pt FFT, 40 MHz may have a 512-pt FFT, and 80 MHz may have a 1024-pt FFT. In some configurations, packets may be generated, transmitted and/or received over a bandwidth of less than or equal to 1.25 megahertz (MHz).

In some configurations, the electronic device 102 may further comprise a user interface 122 in some aspects. The user interface 122 may comprise a keypad, a microphone, a speaker, a mouse, an input port, an output port, and/or a display (e.g., touchscreen). The user interface 122 may include any element or component that conveys information to a user of the electronic device 102 and/or receives input from the user.

The various components of the electronic device 102 may be coupled together by a bus system 124. The bus system 124 may include a data bus, a power bus, a control signal bus, and/or a status signal bus, etc. Additional or alternative bus types may be implemented. Those of skill in the art will appreciate the components of the electronic device 102 may be coupled together or accept or provide inputs to each other using some other mechanism.

Although a number of separate components are illustrated in FIG. 1, one or more of the components may be combined or commonly implemented. For example, the processor 104 may be used to implement not only the functionality described above with respect to the processor 104, but also to implement the functionality described above with respect to the signal detector 118 and/or the DSP 120. Further, each of the components illustrated in FIG. 1 may be implemented using a plurality of separate elements. Furthermore, the processor 104 may be used to implement any of the components, modules, circuits, or the like described below, or each may be implemented using a plurality of separate elements.

FIG. 2 illustrates various components that may be utilized in an electronic device 242 to transmit wireless communications. In some configurations, one or more of the components described in relation to FIG. 2 may be implemented in the electronic device 102 described in relation to FIG. 1. For example, one or more of the components described in relation to FIG. 2 may be implemented in one or more components (e.g., transmitter 110, DSP 120, processor 104, etc.) described in relation to FIG. 1 in some configurations. Additionally or alternatively, the electronic device 242 described in with FIG. 2 may be one example of the electronic device 102 described in relation to FIG. 1. The components illustrated in FIG. 2 may be used, for example, to transmit OFDM communications.

The electronic device 242 of FIG. 2 may comprise a modulator 230 configured to modulate bits for transmission. For example, the modulator 230 may determine a plurality of symbols from bits received from a processor (e.g., processor 104 of FIG. 1) or a user interface (e.g., user interface 122 of FIG. 1), for example, by mapping bits to a plurality of symbols according to a constellation. The bits may correspond to user data or to control information. In some aspects, the bits are received in codewords. In some configurations, the modulator 230 may include a quadrature amplitude modulation (QAM) modulator (e.g., a 16-QAM modulator, a 64-QAM modulator, etc.). In some configurations, the modulator 230 may include a binary phase-shift keying (BPSK) modulator and/or a quadrature phase-shift keying (QPSK) modulator. In some configurations, the modulator 230 may perform training field boosting (e.g., may produce a training field with a higher power than the power of a data field).

The electronic device 242 may include a transformer 232 (e.g., inverse transformer) configured to convert symbols or otherwise modulated bits from the modulator 230 into the time domain. In FIG. 2, the transformer 232 is illustrated as implementing an inverse fast Fourier transform (IFFT). In some implementations, there may be multiple transformers (not shown) that transform units of data of different sizes. In some implementations, the transformer 232 may be itself configured to transform units of data of different sizes. For example, the transformer 232 may be configured with a plurality of modes, and may use a different number of points to convert the symbols in each mode. For example, the IFFT may have a mode where 32 points are used to convert symbols being transmitted over 32 tones (e.g., subcarriers) into a time domain, and a mode where 64 points are used to convert symbols being transmitted over 64 tones into a time domain. The number of points used by the transformer 232 may be referred to as the size of the transformer 232.

In FIG. 2, the modulator 230 and the transformer 232 are illustrated as being implemented in a DSP 240. In some aspects, however, one or both of the modulator 230 and the transformer 232 are implemented in another processor (e.g., processor 104 of FIG. 1) or in another element (e.g., transmitter 110 of FIG. 1).

As discussed above, the DSP 240 may be configured to generate a data unit for transmission. In some aspects, the modulator 230 and the transformer 232 may be configured to generate a data unit including a plurality of fields including control information and a plurality of data symbols. The fields including the control information may include one or more training fields, for example, and one or more signal (SIG) fields in some configurations. Each of the training fields may include a known sequence of values or symbols. Each of the SIG fields may include information about the data unit, for example a description of a length or data rate of the data unit.

One example of a training field that may be included in the data unit (e.g., packet) is a long training field (LTF). As described herein, the power of the LTF may be boosted relative to a data field of the data unit (e.g., packet). For example, the DSP 240 (e.g., modulator 230) and/or the transmitter 238 (e.g., PA 236) may boost the power of the LTF in a preamble of the packet relative to the power of the data field of the packet. For instance, the LTF may have a higher power by some scalar factor in relation to the power of the data field.

In some configurations, the LTF may be designed with low PAPR. For example, the LTF may be a constant modulo time domain sequence with 0 dB PAPR. Additionally or alternatively, clipping and DPD may be applied to the LTF. For example, the DSP 240 may apply clipping and DPD to the LTF.

In some configurations, the electronic device 242 may include a digital to analog converter (DAC) 234 configured to convert the output of the transformer into an analog signal. For example, the time-domain output of the transformer 234 may be converted to a baseband OFDM signal by the digital to analog converter 234. The digital to analog converter 234 may be implemented in a processor (e.g., processor 104) or in another element of the electronic device 242 (e.g., transmitter 110 and/or the DSP 120 of the electronic device 102 of FIG. 1). In some configurations, the digital to analog converter 234 may be implemented in a transceiver (e.g., transceiver 114 of FIG. 1) or in a data transmit processor.

The analog signal may be wirelessly transmitted by the transmitter 238. The analog signal may be further processed before being transmitted by the transmitter 238, for example, by being filtered and/or by being upconverted to an intermediate or carrier frequency. As illustrated in FIG. 2, the transmitter 238 may include a transmit amplifier 236 (e.g., power amplifier (PA)). Prior to being transmitted, the analog signal may be amplified by the transmit amplifier 236. In some configurations, the amplifier 236 may include a low noise amplifier (LNA).

In some configurations of the systems and methods disclosed herein, the transmit amplifier 236 (e.g., PA) may distort the power boosted LTF. One or more of the options described herein may be utilized to ameliorate the distortion. In some approaches (e.g., option 2), the electronic device 242 may send a PA model to the receiver. Additionally or alternatively, the electronic device 242 may determine a PA distortion error for the LTF. The electronic device 242 may send the distortion error to the receiver. The receiver may utilize the PA model and/or the distortion error to regenerate the post-PA transmitted LTF (e.g., the LTF at the output of the transmit amplifier 236). In some approaches (e.g., option 3), the electronic device 242 may apply clipping and DPD to the LTF. The electronic device 242 may determine a clipping error (e.g., distortion) introduced by the clipping. The electronic device 242 may send a clipping level (e.g., a clipping threshold) and/or the clipping error to the receiver. The receiver may utilize the clipping level and/or clipping error to regenerate the post-PA transmitted LTF.

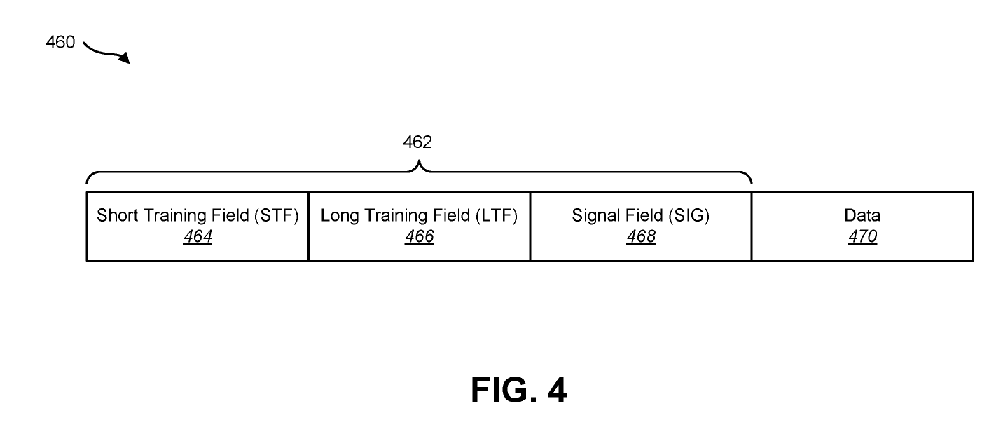

The transmitter 238 may be configured to transmit one or more packets or data units in a wireless signal based on the analog signal. The data units may be generated using a processor (e.g., processor 104 of FIG. 1) and/or the DSP 240, for example, using the modulator 230 and the transformer 232 as discussed above. Data units that may be generated and transmitted as discussed herein are described in additional detail below with respect to one or more of FIGS. 4-5, 7, and 9.

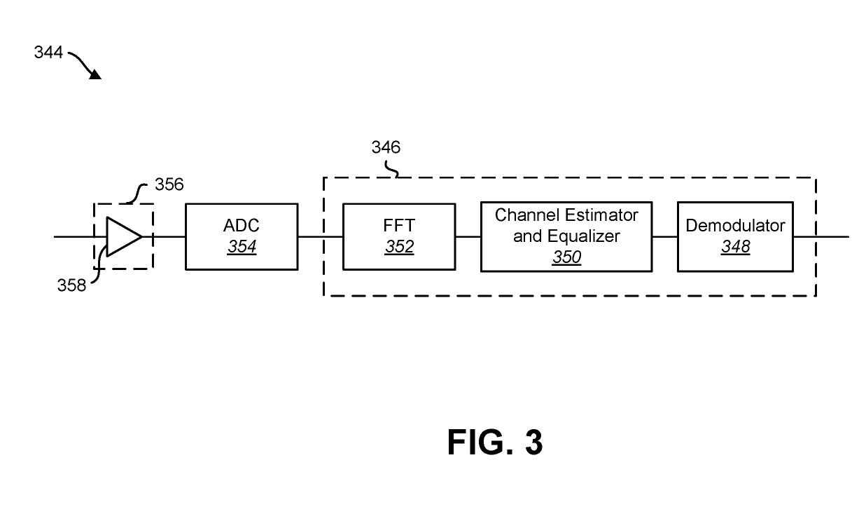

FIG. 3 illustrates various components that may be utilized in an electronic device 344 to receive wireless communications. In some configurations, one or more of the components described in relation to FIG. 3 may be implemented in the electronic device 102 described in relation to FIG. 1. For example, one or more of the components described in relation to FIG. 3 may be implemented in one or more components (e.g., receiver 112, DSP 120, processor 104, etc.) described in relation to FIG. 1 in some configurations. Additionally or alternatively, the electronic device 344 described in with FIG. 3 may be one example of the electronic device 102 described in relation to FIG. 1. The components illustrated in FIG. 3 may be used, for example, to receive OFDM communications. For instance, the components illustrated in FIG. 3 may be used to receive data units transmitted by the components discussed above with respect to FIG. 2.

The receiver 356 of the electronic device 344 may be configured to receive one or more packets or data units in a wireless signal. Data units that may be received and decoded or otherwise processed as discussed herein are described in additional detail with respect to one or more of FIGS. 4, 6, 8, and 10.

The receiver 356 may include a receive amplifier 358. The receive amplifier 358 may be configured to amplify the wireless signal received by the receiver 356. In some aspects, the receiver 356 is configured to adjust the gain of the receive amplifier 358 using an automatic gain control (AGC) procedure. In some aspects, the automatic gain control uses information in one or more received training fields, such as a received short training field (STF) for example, to adjust the gain. In some configurations, the amplifier 358 may include a LNA.

The electronic device 344 may include an analog to digital converter (ADC) 354 configured to convert the amplified wireless signal from the receiver 356 into a digital representation thereof. Further to being amplified, the wireless signal may be processed before being converted by the digital to analog converter 354, for example, by being filtered and/or by being downconverted to an intermediate or baseband frequency. The analog to digital converter 354 may be implemented in a processor (e.g., processor 104 of FIG. 1) or in another element of the electronic device 344 (e.g., receiver 112 and/or the DSP 120 of the electronic device 102 of FIG. 1). In some configurations, the analog to digital converter 354 may be implemented in a transceiver (e.g., transceiver 114 of FIG. 1) or in a data receive processor.

The electronic device 344 may further include a transformer 352 configured to convert the representation of the wireless signal into a frequency spectrum. In FIG. 3, the transformer 352 is illustrated as being implemented by a fast Fourier transform (FFT) module. In some aspects, the transformer 352 may identify a symbol for each point that it uses. As described above with reference to FIG. 2, the transformer 352 may be configured with a plurality of modes, and may use a different number of points to convert the signal in each mode. For example, the transformer 352 may have a mode where 32 points are used to convert a signal received over 32 tones into a frequency spectrum, and a mode where 64 points are used to convert a signal received over 64 tones into a frequency spectrum. The number of points used by the transformer 352 may be referred to as the size of the transformer 352. In some aspects, the transformer 352 may identify a symbol for each point that it uses.

The electronic device 344 may further include a channel estimator and equalizer 350 configured to form an estimate of the channel over which the data unit is received, and/or to remove certain effects of the channel based on the channel estimate. For example, the channel estimator 350 may be configured to approximate a function of the channel, and the channel equalizer may be configured to apply an inverse of that function to the data in the frequency spectrum.

In some aspects, the channel estimator and equalizer 350 uses information in one or more received training fields, such as a long training field (LTF) for example, to estimate the channel. The channel estimate may be formed based on one or more LTFs received in a preamble (at the beginning of the data unit, for example). This channel estimate may thereafter be used to equalize data symbols that follow the one or more LTFs. In some configurations, the channel estimator and equalizer 350 may deboost the channel estimate (e.g., divide the channel estimate by a factor, such as \sqrt{2}). After a certain period of time or after a certain number of data symbols, one or more additional LTFs may be received in the data unit. The channel estimate may be updated or a new estimate formed using the additional LTFs. This new or updated channel estimate may be used to equalize data symbols that follow the additional LTFs. In some aspects, the new or updated channel estimate may be used to re-equalize data symbols preceding the additional LTFs.

The electronic device 344 may further include a demodulator 348 configured to demodulate the equalized data. For example, the demodulator 348 may determine a plurality of bits from symbols output by the transformer 352 and the channel estimator and equalizer 350, for example by reversing a mapping of bits to a symbol in a constellation. In some configurations, the demodulator 348 may demodulate a data field based on the channel estimate (e.g., the deboosted channel estimate). The bits may be processed or evaluated by a processor (e.g., processor 104 of FIG. 1), or used to display or otherwise output information (to a user interface 122 as illustrated in FIG. 1, for example). In this way, data and/or information may be decoded. In some aspects, the bits correspond to codewords. In some configurations, the demodulator 348 may include a QAM (quadrature amplitude modulation) demodulator, for example, a 16-QAM demodulator and/or a 64-QAM demodulator. In other aspects, the demodulator 348 may include a binary phase-shift keying (BPSK) demodulator and/or a quadrature phase-shift keying (QPSK) demodulator.

In some configurations of the systems and methods disclosed herein, the electronic device 344 (e.g., DSP 346) may be configured to receive and/or utilize a power-boosted LTF. In some approaches (e.g., option 1), the electronic device 344 may receive a LTF that is designed with a low PAPR. For example, the LTF may be time domain sequence. In some approaches, the low PAPR of the LTF plus a power boosting amount in decibels (dB) may be lower than an average PAPR of the data field. The channel estimator 350 may estimate the channel based on the power boosted LTF. The demodulator 348 may demodulate a data field of a packet based on the estimated channel with deboosting.

In some approaches (e.g., option 2), the electronic device 344 may receive a PA model and/or PA distortion error from the transmitter. The electronic device 344 (e.g., DSP 346) may regenerate the post-PA transmitted LTF (corresponding to a LTF after a PA operation, at the output of a PA, for example) based on the PA model or the PA distortion error. The channel estimator 350 may estimate the channel based on the regenerated post-PA transmitted LTF and/or may deboost the channel estimate. The demodulator 348 may demodulate a data field of a packet based on the estimated channel with deboosting.

In some approaches (e.g., option 3), the electronic device 344 may receive a clipping level and/or a clipping error from the transmitter. The electronic device 344 (e.g., DSP 346) may regenerate the post-PA transmitted LTF (after a PA operation, at the output of a PA, for example) based on a known LTF sequence and the clipping error and/or clipping level. The channel estimator 350 may estimate the channel based on the regenerated post-PA transmitted LTF. The demodulator 348 may demodulate a data field of a packet based on the estimated channel with deboosting.

In FIG. 3, the transformer 352, the channel estimator and equalizer 350, and/or the demodulator 348 are illustrated as being implemented in the DSP 346. In some aspects, however, one or more of the transformer 352, the channel estimator and equalizer 350, and the demodulator 348 are implemented in another processor (e.g., processor 104 of FIG. 1) or in another element (e.g., receiver 112 of FIG. 1).

As discussed above, the wireless signal received at the receiver 356 includes one or more data units. Using the functions and/or components described above, the data units or data symbols therein may be decoded, evaluated, and/or otherwise evaluated or processed. For example, a processor (e.g., processor 104 of FIG. 1) and/or the DSP 346 may be used to decode data symbols in the data units using the transformer 352, the channel estimator and equalizer 350, and the demodulator 348.

Data units exchanged by electronic devices (e.g., APs and STAs) may include control information or data, as discussed above. At the physical (PHY) layer, these data units may be referred to as physical layer protocol data units (PPDUs). In some aspects, a PPDU may be referred to as a packet or physical layer packet. Each PPDU may include a preamble and a payload. The preamble may include one or more training fields and a SIG field. The payload may include a Media Access Control (MAC) header, data for other layers, and/or user data, for example. The payload may be transmitted using one or more data symbols. Some configurations of the systems, methods, and devices disclosed herein may utilize data units with boosted training fields (e.g., boosted LTFs).

The electronic device 242 shown in FIG. 2 illustrates an example of a single transmit chain to be transmitted over an antenna. The electronic device 344 shown in FIG. 3 shows an example of a single receive chain to be received over an antenna. In some implementations, the electronic device 242 of FIG. 2 and/or the electronic device 344 of FIG. 3 may implement a portion of a MIMO system using multiple antennas to concurrently transmit and/or receive data.

FIG. 4 is a block diagram showing one example of a preamble 462 and data 470 (e.g., payload) of a physical layer packet 460. The preamble 462 may include a short training field (STF) 464 that includes an STF sequence of known values. In some aspects, the STF 464 may be used for packet detection (e.g., to detect the start of a packet) and for coarse time/frequency estimation. In some configurations, the STF sequence may be optimized to have a low PAPR and include a subset of non-zero tones with a particular periodicity. The STF 464 may span one or multiple OFDM symbols.

In some configurations, the preamble 462 may further include a long training field (LTF) 466 that may span one or multiple OFDM symbols and may include one or more LTF sequences of predetermined (e.g., known) non-zero values. The LTF may be used for channel estimation, fine time/frequency estimation, and/or mode detection. The LTF 466 may be boosted in power as described herein. For example, the LTF 466 may have a higher power relative to the power of the data field 470. For instance, instead of having a STF, LTF, and/or data portions with the same power, some configurations of the systems and methods disclosed herein may boost the power of the LTF 466 relative to the power of the data field 470. In some configurations, the preamble 462 may include a signal field (SIG) 468 as described above that may include a number of bits or values used in one aspect for mode detection purposes and/or determination of transmission parameters.

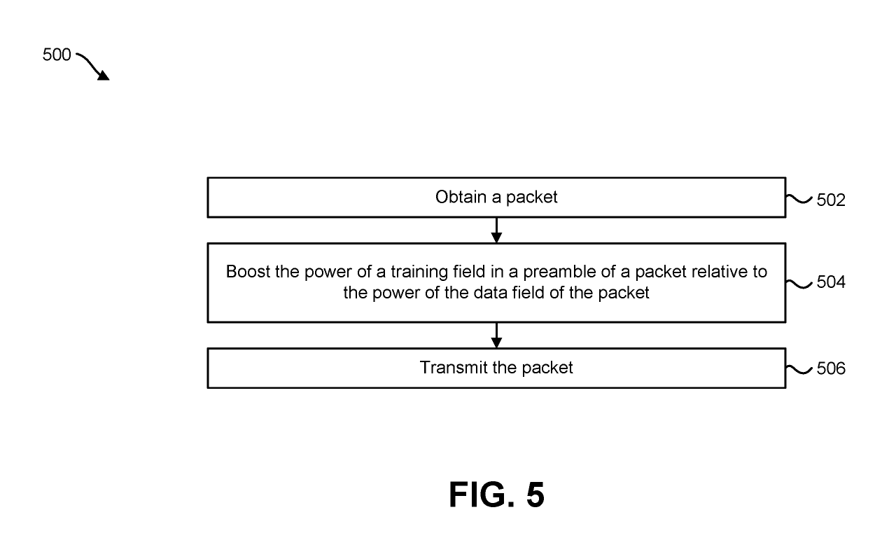

FIG. 5 is a flow diagram illustrating an example of a method 500 for training field boosting. The method 500 may be performed by one or more of the electronic devices 102, 242 described herein.

The electronic device 102 may obtain 502 a packet. This may be accomplished as described in relation to FIG. 1. For example, the electronic device 102 may generate a packet with a preamble and a data field. The packet may include control information and/or payload data. For example, the data field may include data from a processor (e.g., from one or more applications and/or user interface data). The preamble may include one or more training fields (e.g., STF, LTF) and/or a signal field (e.g., SIG).

The electronic device 102 may boost 504 the power of a training field (e.g., LTF) in a preamble of a packet relative to the power of the data field of the packet. This may be accomplished as described in relation to FIG. 1. For example, the electronic device 102 may control a modulator to generate a training field with higher amplitudes (relative to a data field, for example). For instance, the modulator may increase the amplitude(s) of the training field relative to the amplitude(s) of the data field. Boosting 504 the power of the training field may include multiplying the training field (e.g., training field sequence) by a factor (e.g., \sqrt{2}).

In some configurations, the training field (e.g., LTF) may be designed with a low PAPR. For example, the training field may be a time domain sequence. In some configurations, the low PAPR of the training field plus a power boosting amount in dB may be lower than an average PAPR of the data field.

The electronic device 102 may transmit 506 the packet. This may be accomplished as described in relation to one or more of FIGS. 1-2. For example, the electronic device 102 may radiate the packet as an electromagnetic signal using one or more antennas.

In some configurations, the electronic device 102 may determine and/or send a PA model and/or a PA distortion error. Additionally or alternatively, the electronic device 102 may determine and/or send a clipping level and/or a clipping error.

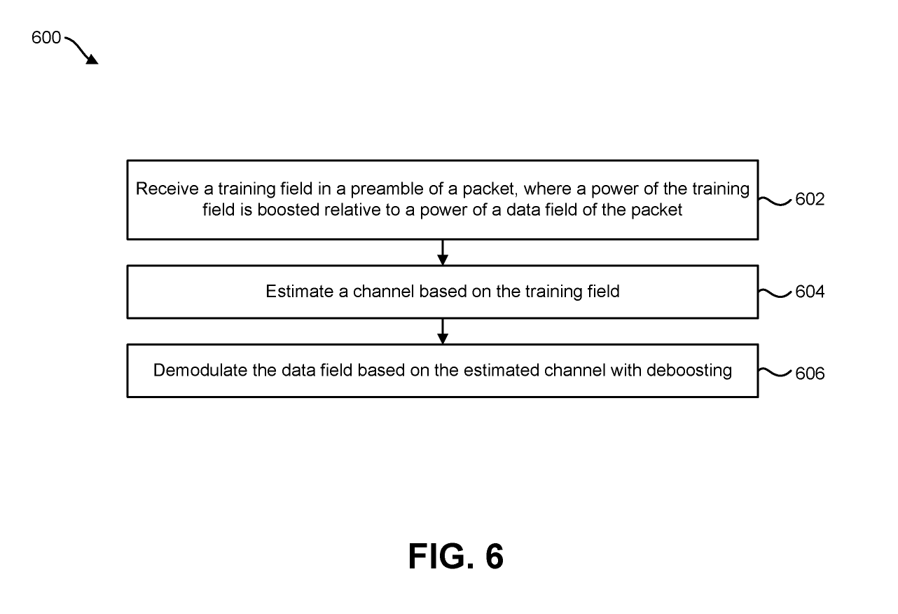

FIG. 6 is a flow diagram illustrating an example of another method 600 for training field boosting. The method 600 may be performed by one or more of the electronic devices 102, 346 described herein.

The electronic device 102 may receive 602 a training field (e.g., LTF) in a preamble of a packet, where the power of the training field may be boosted relative to a power of a data field of the packet. This may be accomplished as described in relation to FIG. 1. In some configurations, the training field may be designed with a low PAPR. For example, the training field may be a time domain sequence. In some configurations, the low PAPR of the training field plus a power boosting amount in dB may be lower than an average PAPR of the data field.

The electronic device 102 may estimate 604 a channel based on the training field (e.g., LTF). This may be accomplished as described in relation to FIG. 1. For example, the electronic device 102 may estimate the channel based on a low PAPR training field (e.g., a time-domain sequence). Additionally or alternatively, the electronic device 102 may regenerate a post-PA transmitted training field (e.g., LTF) based on a PA model, a PA distortion error, a clipping error, and/or a clipping level. The electronic device 102 may estimate 604 the channel based on the received training field and the regenerated post-PA transmitted training field.

The electronic device 102 may demodulate 606 the data field based on the estimated channel with deboosting. This may be accomplished as described in relation to FIG. 1. For example, the electronic device 102 may divide the channel estimate by a factor (e.g., \sqrt{2}) to deboost the channel estimate. The electronic device 102 may utilize the channel estimate (e.g., deboosted channel estimate) to demodulate the data field.

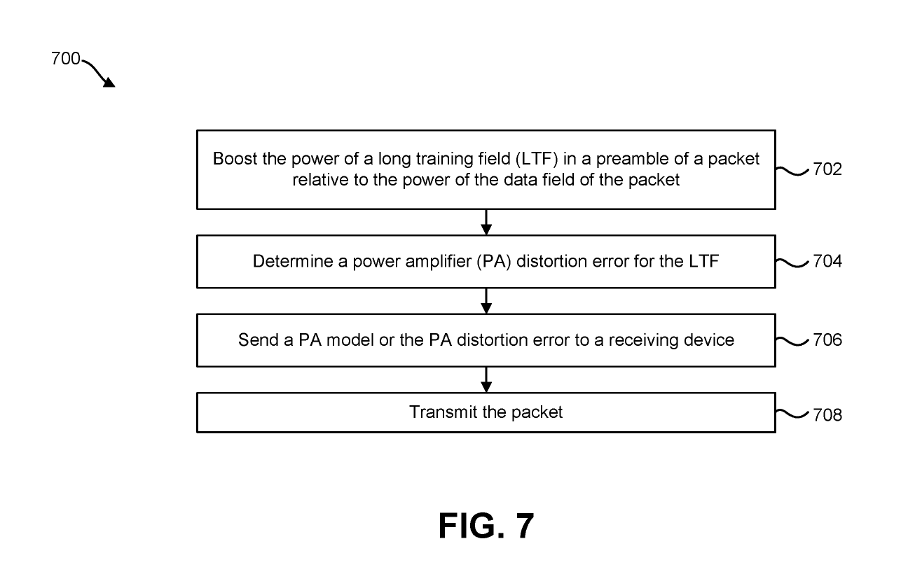

FIG. 7 is a flow diagram illustrating a more specific example of a method 700 for training field boosting. The method 700 may be performed by one or more of the electronic devices 102, 242 described herein.

The electronic device 102 may boost 702 the power of a LTF in a preamble of a packet relative to the power of the data field of the packet. This may be accomplished as described in relation to FIG. 1. For example, the electronic device 102 (e.g., DSP, modulator, and/or PA, etc.) may produce a packet with a LTF that has a higher power than the power of the data field (by a factor, such as 3 dB, for instance). In some configurations, boosting 702 the power of the training field may include multiplying the training field (e.g., training field sequence) by a factor (e.g., \sqrt{2}). For example, a modulator may multiply the LTF by a factor to boost the LTF.

The electronic device 102 may optionally determine 704 a PA distortion error for the LTF. This may be accomplished as described in relation to FIG. 1. For example, the electronic device 102 may determine the distortion of the LTF due to the PA.

The electronic device 102 may optionally send 706 a PA model and/or the PA distortion to a receiving device. This may be accomplished as described in relation to FIG. 1. In some configurations, the electronic device 102 may send 706 the PA distortion (e.g., one or more numeric values that indicate the PA distortion in the LTF). The PA distortion may be sent 706 as part of the packet or in a separate transmission. Additionally or alternatively, one or more distortion-related parameters (e.g., PA backoff and/or clipping threshold, etc.) may be sent (e.g., signaled) in the current packet in a control field or through association. In some configurations, the electronic device 102 may send 706 a PA model to the receiving device. The PA model may be a model that indicates one or more characteristics (e.g., a transfer function) of the PA. The PA model may be sent in the packet or in a separate transmission. In some implementations, the PA model may be predetermined. The PA model may be expressed as a polynomial (e.g., a number of terms and corresponding coefficients).

It should be noted that in some configurations, the electronic device 102 may not determine 704 a PA distortion error. For example, the electronic device 102 may not determine and/or send the PA distortion in some approaches where the PA model is sent (e.g., only the PA model, not the PA distortion error). In other approaches, the electronic device 102 may determine 704 the PA distortion error and send 706 both the PA model and the PA distortion error.

The electronic device 102 may transmit 708 the packet. This may be accomplished as described in relation to FIG. 1. For example, the electronic device 102 may radiate the packet as an electromagnetic signal using one or more antennas.

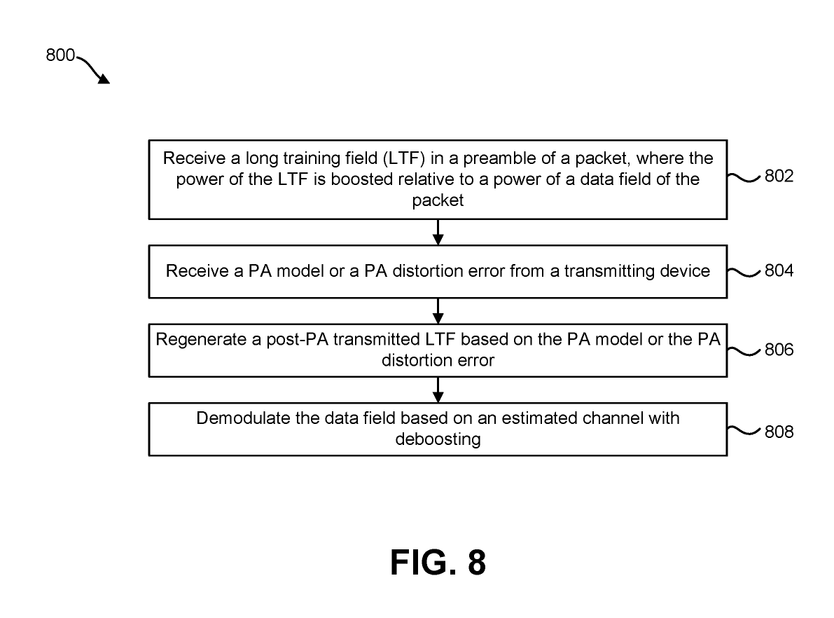

FIG. 8 is a flow diagram illustrating another more specific example of a method 800 for training field boosting. The method 800 may be performed by one or more of the electronic devices 102, 344 described herein.

The electronic device 102 may receive 802 a LTF in a preamble of a packet, where the power of the LTF may be boosted relative to a power of a data field of the packet. This may be accomplished as described in relation to FIG. 1.

The electronic device 102 may receive 804 a PA model and/or a PA distortion error from a transmitting device. This may be accomplished as described in relation to FIG. 1. The PA distortion error may include one or more numeric values that indicate the PA distortion in the LTF resulting from the operation of the PA of the transmitting device. The PA distortion error may be received 804 as part of the packet or in a separate transmission. Additionally or alternatively, the PA model may be a model that indicates one or more characteristics (e.g., a transfer function) of the PA of the transmitting device. The PA model may be received 804 as part of the packet or in a separate transmission. In some configurations, the PA model may indicate a polynomial (e.g., a number of terms and corresponding coefficients).

The electronic device 102 may regenerate 806 a post-PA transmitted LTF based on the PA model and/or the PA distortion error. This may be accomplished as described in relation to FIG. 1. For example, the electronic device 102 may regenerate 806 the post-PA transmitted LTF as a sum of a predetermined and the PA distortion error of the LTF as described above. Additionally or alternatively, the electronic device 102 may regenerate 806 the post-PA transmitted LTF based on the PA model. For example, the electronic device 102 may determine the post-PA transmitted LTF by applying the PA model to the predetermined LTF sequence. The electronic device 102 may determine an estimated channel based on the regenerated post-PA transmitted LTF.

The electronic device 102 may demodulate 808 the data field based on the estimated channel with deboosting. This may be accomplished as described in relation to FIG. 1. For example, the electronic device 102 may divide the channel estimate by a factor (e.g., \sqrt{2}) to deboost the channel estimate. The electronic device 102 may utilize the channel estimate (e.g., deboosted channel estimate) to demodulate the data field.

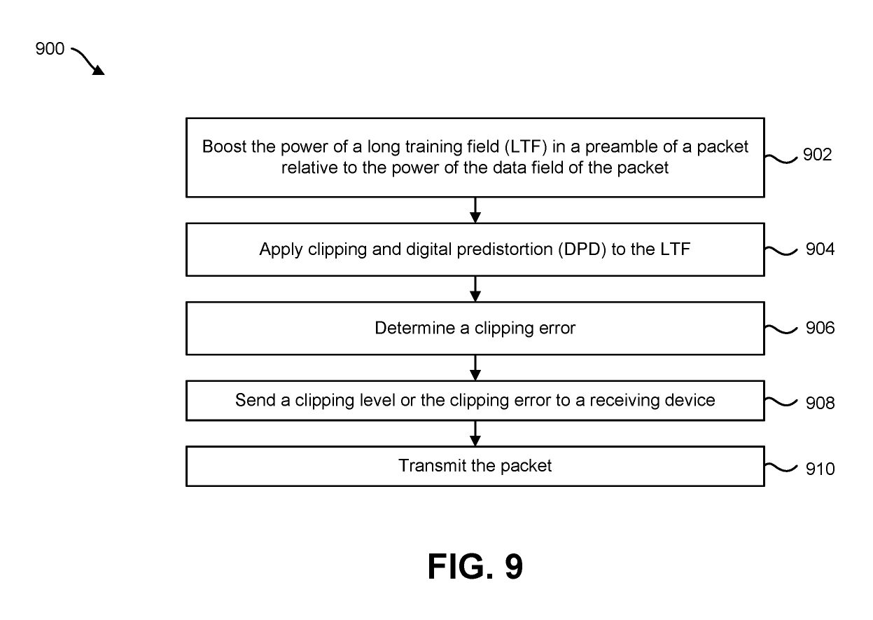

FIG. 9 is a flow diagram illustrating another more specific example of a method 900 for training field boosting. The method 900 may be performed by one or more of the electronic devices 102, 242 described herein.

The electronic device 102 may boost 902 the power of a LTF in a preamble of a packet relative to the power of the data field of the packet. This may be accomplished as described in relation to FIG. 1. For example, the electronic device 102 may produce a packet with a LTF that has a higher power than the power of the data field (by a factor, such as 3 dB, for instance).

The electronic device 102 may apply 904 clipping and DPD to the LTF. This may be accomplished as described in relation to FIG. 1. For example, the electronic device 102 may clip LTF signal magnitudes that are greater than a clipping level (e.g., threshold). The clipping function may be predetermined. The electronic device 102 may also apply DPD to the LTF. For example, the electronic device 102 may apply an approximately inverse distortion (e.g., inverse to the distortion of the PA) to the LTF. DPD may be applied before the LTF is provided to the PA.

The electronic device 102 may optionally determine 906 a clipping error for the LTF. This may be accomplished as described in relation to FIG. 1. For example, the electronic device 102 may determine the clipping error (e.g., distortion) of the LTF due to the clipping.

The electronic device 102 may optionally send 908 a clipping level and/or the clipping error to a receiving device. This may be accomplished as described in relation to FIG. 1. In some configurations, the electronic device 102 may send 906 the clipping error (e.g., one or more numeric values that indicate the clipping error in the LTF). The clipping error may be sent 908 as part of the packet or in a separate transmission. In some configurations, the electronic device 102 may send 908 a clipping level (e.g., clipping threshold) to the receiving device. The clipping level may indicate a level (e.g., threshold) at which the LTF is clipped. The clipping level may be sent in the packet or in a separate transmission.

It should be noted that in some configurations, the electronic device 102 may not determine 906 a clipping error. For example, the electronic device 102 may not determine and/or send the clipping error in some approaches where the clipping level is sent. In other approaches, the electronic device 102 may determine 904 the clipping error and send 908 both the clipping level and the clipping error.

In some configurations, the electronic device 102 may optionally filter OOBE. For example, the electronic device 102 may apply a filter to the LTF (after PA operation) that reduces OOBE.

The electronic device 102 may transmit 910 the packet. This may be accomplished as described in relation to FIG. 1. For example, the electronic device 102 may radiate the packet as an electromagnetic signal using one or more antennas.

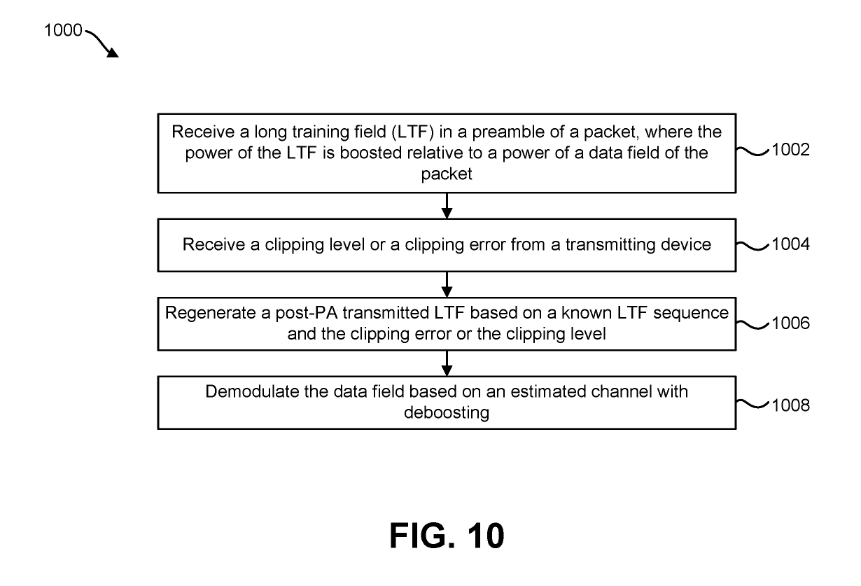

FIG. 10 is a flow diagram illustrating another example of a method 1000 for utilizing a boosted training field. The method 1000 may be performed by one or more of the wireless devices described herein (e.g., electronic device 102, 344, etc.).

The electronic device 102 may receive 1002 a LTF in a preamble of a packet, where the power of the LTF may be boosted relative to a power of a data field of the packet. This may be accomplished as described in relation to FIG. 1.

The electronic device 102 may receive 1004 a clipping level and/or a clipping error from a transmitting device. This may be accomplished as described in relation to FIG. 1. The clipping error may include one or more numeric values that indicate the distortion in the LTF resulting from the clipping performed by the transmitting device. The clipping error may be received 1004 as part of the packet or in a separate transmission. Additionally or alternatively, the clipping level may indicate a clipping threshold employed by the transmitting device. The clipping level may be received 1004 as part of the packet or in a separate transmission.

The electronic device 102 may regenerate 1006 a post-PA transmitted LTF based on a known LTF sequence and the clipping level and/or the clipping error. This may be accomplished as described in relation to FIG. 1. For example, the electronic device 102 may regenerate 1006 the post-PA transmitted LTF as a sum of a known LTF plus the clipping error of the LTF as described above. Additionally or alternatively, the electronic device 102 may regenerate 1006 the post-PA transmitted LTF based on the clipping level. For example, the electronic device 102 may apply the clipping level to the known LTF to determine the clipped LTF (e.g., post-PA transmitted LTF). The electronic device 102 may determine an estimated channel based on the regenerated post-PA transmitted LTF.

The electronic device 102 may demodulate 1008 the data field based on the estimated channel with deboosting. This may be accomplished as described in relation to FIG. 1.

It should be noted that two or more of the steps, functions, procedures, and/or methods described in relation to FIGS. 5, 7, and/or 9 may be combined in some configurations and/or may be performed in a different order in some configurations. Additionally or alternatively, two or more of the steps, functions, procedures, and/or methods described in relation to FIGS. 6, 8, and/or 10 may be combined in some configurations and/or may be performed in a different order in some configurations.

FIG. 11 is a diagram illustrating an example of a wireless communication system 1172 in which aspects of the systems and methods disclosed herein may be employed. In some configurations, the wireless communication system 1172 may operate pursuant to a wireless standard (e.g., one or more of the family of 802.11 standards). The wireless communication system 1172 may include an access point (AP) 1176, which communicates with stations (STAs) 1178a, 1178b, 1178c, and 1178d (collectively STAs 1178).

A variety of procedures and/or methods may be used for transmissions in the wireless communication system 1172 between the AP 1176 and the STAs 1178. For example, signals may be sent and received between the AP 1176 and the STAs 1178 in accordance with orthogonal frequency-division multiplexing (OFDM) and/or orthogonal frequency-division multiple access (OFDMA) techniques. If this is the case, the wireless communication system 1172 may be referred to as an OFDM/OFDMA system. Additionally or alternatively, signals may be sent and received between the AP 1176 and the STAs 1178 in accordance with code division multiple access (CDMA) techniques. If this is the case, the wireless communication system 1172 may be referred to as a CDMA system. Other techniques may be utilized.

A communication link that facilitates transmission from the AP 1176 to one or more of the STAs 1178 may be referred to as a downlink (DL) 1180, and a communication link that facilitates transmission from one or more of the STAs 1178 to the AP 1176 may be referred to as an uplink (UL) 1182. Additionally or alternatively, a downlink 1180 may be referred to as a forward link or a forward channel, and/or an uplink 1182 may be referred to as a reverse link or a reverse channel.

The AP 1176 may act as a base station and provide wireless communication coverage in a basic service area (BSA) 1174. The AP 1176 along with the STAs 1178 associated with the AP 1176 and that use the AP 1176 for communication may be referred to as a basic service set (BSS). It should be noted that the wireless communication system 1172 may not have a central AP 1176, but rather may function as a peer-to-peer network between the STAs 1178. Accordingly, the functions of the AP 1176 described herein may alternatively be performed by one or more of the STAs 1178.

The AP 1176 may be an example of the electronic device 102 described in relation to FIG. 1. Additionally or alternatively, one or more of the STAs 1178 may be examples of the electronic device 102 described in relation to FIG. 1. One or more of the AP 1176 and/or STA(s) 1178a-d may employ training field (e.g., LTF) boosting in accordance with one or more of the configurations described herein. For example, one or more of the AP 1176 and/or the STA(s) 1178a-d may boost a LTF of a preamble and/or may utilize a low PAPR LTF, PA post correction, and/or clipping with DPD as described herein. Additionally or alternatively, one or more of the AP 1176 and/or STAs 1178a-d may perform channel estimation based on the boosted LTF and/or may demodulate a data field with deboosting as described herein.

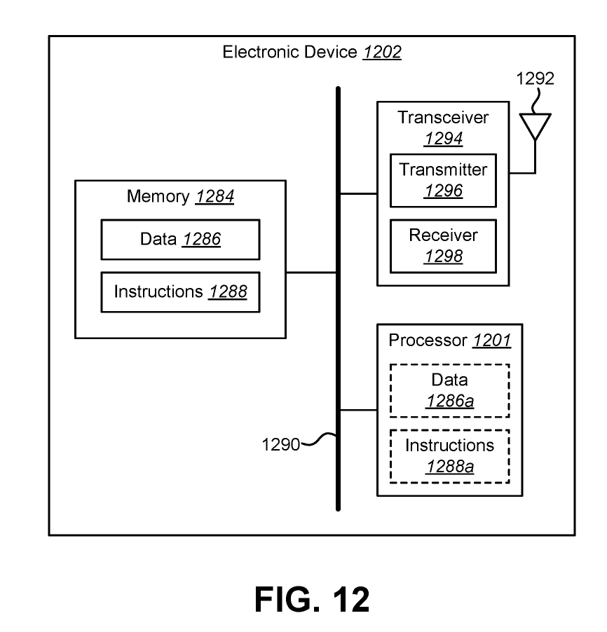

FIG. 12 illustrates certain components that may be included within an electronic device 1202. The electronic device 1202 described in relation to FIG. 12 may be implemented in accordance with one or more of the electronic devices (e.g., electronic device 102, 242, 344, AP 1176, STA 1178, etc.) described herein.

The electronic device 1202 includes a processor 1201. The processor 1201 may be a general purpose single- or multi-chip microprocessor (e.g., an ARM), a special purpose microprocessor (e.g., a digital signal processor (DSP)), a microcontroller, a programmable gate array, etc. The processor 1201 may be referred to as a central processing unit (CPU). Although just a single processor 1201 is shown in the electronic device 1202 of FIG. 12, in an alternative configuration, a combination of processors (e.g., an ARM and DSP) could be used.

The electronic device 1202 also includes memory 1284 in electronic communication with the processor 1201 (e.g., the processor 1201 can read information from and/or write information to the memory 1284). The memory 1284 may be any electronic component capable of storing electronic information. The memory 1284 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 1286 and instructions 1288 may be stored in the memory 1284. The instructions 1288 may include one or more programs, routines, sub-routines, functions, procedures, code, etc. The instructions 1288 may include a single computer-readable statement or many computer-readable statements. The instructions 1288 may be executable by the processor 1201 to implement one or more of the methods 500, 600, 700, 800, 900, 1000 described herein. For example, the processor 1201 may boost a training field, utilize the boosted training field, and/or utilize a PA model, a PA distortion error, clipping, and/or DPD, etc., as described herein. Executing the instructions 1288 may involve the use of the data 1286 that is stored in the memory 1284. FIG. 12 shows some instructions 1288a and data 1286a being loaded into the processor 1201.

The electronic device 1202 may also include a transmitter 1296 and a receiver 1298 to allow transmission and reception of signals between the electronic device 1202 and a remote location (e.g., another electronic device). The transmitter 1296 and receiver 1298 may be collectively referred to as a transceiver 1294. An antenna 1292 may be electrically coupled to the transceiver 1294. The electronic device 1202 may also include (not shown) multiple transmitters, multiple receivers, multiple transceivers and/or multiple antennas.

The various components of the electronic device 1202 may be coupled together by one or more buses, which may include a power bus, a control signal bus, a status signal bus, a data bus, etc. For simplicity, the various buses are illustrated in FIG. 12 as a bus system 1290.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer or processor. Disk and disc, as used herein, includes compact disc (CD), laser disc, optical disc, digital versatile disc (DVD), floppy disk, and Blu-Ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed, or computed by the computing device or processor. As used herein, the term “code” may refer to software, instructions, code, or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL) or wireless technologies such as infrared, radio and microwave, then the coaxial cable, fiber optic cable, twisted pair, DSL or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the systems, methods, and apparatus described herein without departing from the scope of the claims.

What is claimed is:

1. A method performed by an electronic device, comprising:
receiving a long training field (LTF) in a preamble of a packet, wherein a power of the LTF is boosted relative to a power of a data field of the packet;
receiving a power amplifier (PA) model or a PA distortion error from a transmitting device;
regenerating a post-PA transmitted LTF based on the PA model or the PA distortion error; and
demodulating the data field based on an estimated channel with deboosting.

2. The method of claim 1, further comprising determining the estimated channel based on the regenerated post-PA transmitted LTF.

3. The method of claim 2, further comprising determining a noise estimate, and wherein determining the estimated channel is based on the received LTF, the regenerated post-PA transmitted LTF, and the noise estimate.

4. The method of claim 1, wherein regenerating the post-PA transmitted LTF comprises adding the PA distortion error to a predetermined LTF to produce the post-PA transmitted LTF.

5. The method of claim 1, wherein regenerating the post-PA transmitted LTF comprises applying the PA model to a predetermined LTF to produce the post-PA transmitted LTF.

6. The method of claim 1, wherein the PA distortion error indicates a PA distortion applied to the LTF by the transmitting device.

7. The method of claim 1, wherein the power of the LTF is boosted for multiple streams.

8. The method of claim 1, wherein the power of the LTF is boosted for a modulation and coding scheme (MCS) that is higher than a base MCS.

9. The method of claim 1, wherein boosting the power of the LTF results in increased PA distortion for the LTF relative to PA distortion for the data field, and wherein regenerating the post-PA transmitted LTF reduces channel estimation error due to the increased PA distortion.

10. An electronic device, comprising:
a receiver configured to receive a long training field (LTF) in a preamble of a packet, wherein a power of the LTF is boosted relative to a power of a data field of the packet, and configured to receive a power amplifier (PA) model or a PA distortion error from a transmitting device;
a processor configured to regenerate a post-PA transmitted LTF based on the PA model or the PA distortion error; and
a demodulator configured to demodulate the data field based on an estimated channel with deboosting.

11. The electronic device of claim 10, wherein the processor is configured to determine the estimated channel based on the regenerated post-PA transmitted LTF.

12. The electronic device of claim 11, wherein the processor is configured to determine a noise estimate, and wherein determining the estimated channel is based on the received LTF, the regenerated post-PA transmitted LTF, and the noise estimate.

13. The electronic device of claim 10, wherein the processor is configured to regenerate the post-PA transmitted LTF by adding the PA distortion error to a predetermined LTF to produce the post-PA transmitted LTF.

14. The electronic device of claim 10, wherein the processor is configured to regenerate the post-PA transmitted LTF by applying the PA model to a predetermined LTF to produce the post-PA transmitted LTF.

15. The electronic device of claim 10, wherein the PA distortion error indicates a PA distortion applied to the LTF by the transmitting device.

16. The electronic device of claim 10, wherein the power of the LTF is boosted for multiple streams.

17. The electronic device of claim 10, wherein the power of the LTF is boosted for a modulation and coding scheme (MCS) that is higher than a base MCS.

18. The electronic device of claim 10, wherein boosting the power of the LTF results in increased PA distortion for the LTF relative to PA distortion for the data field, and wherein the processor is configured to regenerate the post-PA transmitted LTF to reduce channel estimation error due to the increased PA distortion.

19. A non-transitory tangible computer-readable medium storing computer-executable code, comprising:
code for causing an electronic device to receive a long training field (LTF) in a preamble of a packet, wherein a power of the LTF is boosted relative to a power of a data field of the packet;
code for causing the electronic device to receive a power amplifier (PA) model or a PA distortion error from a transmitting device;
code for causing the electronic device to regenerate a post-PA transmitted LTF based on the PA model or the PA distortion error; and
code for causing the electronic device to demodulate the data field based on an estimated channel with deboosting.

20. The computer-readable medium of claim 19, further comprising code for causing the electronic device to determine the estimated channel based on the regenerated post-PA transmitted LTF.

21. The computer-readable medium of claim 19, wherein the code for causing the electronic device to regenerate the post-PA transmitted LTF comprises code for causing the electronic device to add the PA distortion error to a predetermined LTF to produce the post-PA transmitted LTF.

22. The computer-readable medium of claim 19, wherein the code for causing the electronic device to regenerate the post-PA transmitted LTF comprises code for causing the electronic device to apply the PA model to a predetermined LTF to produce the post-PA transmitted LTF.

23. The computer-readable medium of claim 19, wherein the power of the LTF is boosted for multiple streams.

24. The computer-readable medium of claim 19, wherein the power of the LTF is boosted for a modulation and coding scheme (MCS) that is higher than a base MCS.

25. An apparatus, comprising:
means for receiving a long training field (LTF) in a preamble of a packet, wherein a power of the LTF is boosted relative to a power of a data field of the packet;
means for receiving a power amplifier (PA) model or a PA distortion error from a transmitting device;
means for regenerating a post-PA transmitted LTF based on the PA model or the PA distortion error; and
means for demodulating the data field based on an estimated channel with deboosting.

26. The apparatus of claim 25, further comprising means for determining the estimated channel based on the regenerated post-PA transmitted LTF.

27. The apparatus of claim 25, wherein the means for regenerating the post-PA transmitted LTF comprises means for adding the PA distortion error to a predetermined LTF to produce the post-PA transmitted LTF.

28. The apparatus of claim 25, wherein the means for regenerating the post-PA transmitted LTF comprises means for applying the PA model to a predetermined LTF to produce the post-PA transmitted LTF.

29. The apparatus of claim 25, wherein the power of the LTF is boosted for multiple streams.

30. The apparatus of claim 25, wherein the power of the LTF is boosted for a modulation and coding scheme (MCS) that is higher than a base MCS.
